(19) United States
(12) Patent Application Publication
(10) Pub. No.: US 2002/0095391 A1
(43) Pub. Date: Jul. 18, 2002

(54) Methods and apparatus for providing variable price structures for time-based services available through a transaction system

(76) Inventors: Garret Swart, (US); Pete Duimstra, San Mateo, CA (US); Nathan Boyd, San Francisco, CA (US); Nino Walker, Palo Alto, CA (US); Laurent Demailly, Belmont, CA (US); John Lee, Palo Alto, CA (US); Celia Francis, San Francisco, CA (US); Mike Rauta, Rockville, MD (US); Gabiel Manjarrez, Menlo Park, CA (US)

Correspondence Address: CENTRAL COAST PATENT AGENCY, PO BOX 187, AROMAS, CA, 95004, US

(21) Appl. No.: 09/737,416

(22) Filed: Dec. 14, 2000

Related U.S. Application Data
(62) Division of application No. 09/594,419, filed on Jun. 14, 2000.

(51) Int. Cl. G06F 17/00

(52) U.S. Cl. 705/400

(57) ABSTRACT

In a database-driven transaction system, a dynamic-pricing mechanism for setting prices for timebased services offered and available through an interactive interface of the transaction system is provided. The mechanism comprises a floating time window for identifying a span of time in which services are available to be engaged; an averaging function for determining an average price paid to a single or multiple suppliers for services offered; a scaling function for dividing the time window into definitive time units; and a price-adjustment function for adjusting prices paid by customers for services according to position of engagement of said services within the time window. In some embodiments the price-adjusting function is based on service inventory levels defined at the time of potential engagements within the time window. In still other embodiments, the price-adjusting function is programmed according to calendar and or time considerations. Also in some embodiments, the price-adjusting function is temporarily disabled for the purpose of holding various types of auction sales.

### CROSS-REFERENCE TO RELATED DOCUMENTS

The present invention is a divisional of U.S. patent application Ser. No. 09/594,419, filed Jun. 14, 2000 and entitled “Methods and Apparatus for Marketing Reservable Services”, disclosure of which is included herein in its entirety by reference.

### FIELD OF THE INVENTION

The present invention is in the area of services provided by service suppliers, pertaining generally to methods and apparatus for marketing services that may be reserved by customers through a variety of communication systems and interfaces, and more particularly to methods and apparatus for pricing services in a dynamic and flexible manner.

### BACKGROUND OF THE INVENTION

The phenomenal growth of the public network known as the Internet is notoriously well-known at the time of the present patent application. This growth has been, and continues to be, in the sheer number of the end-users, in the number and diversity of hosting enterprises providing information and services to the users, and in the quantity and quality of equipment and interconnections making out the physical presence of the Internet.

The phenomenon of the Internet network motivates continuing development in every aspect. End-user equipment and software is evolving at a rapid rate, bringing more versatile Internet capable appliances, for example. Means for and bandwidth of connections are evolving as well, as is the capability of data transfer systems, such as routers in the network.

Another area of significant development in the Internet world is in services provided by enterprises hosting service centers on the Internet. There have been hundreds of new, and in many cases innovative business models, or new ways of doing business. The present invention, in many aspects, is in this technology category.

The presence, growth, and development of the Internet is a communication phenomenon. The Internet is providing new, better, and faster means of communication. Because all human transactions, being agreements reached between persons after consideration of alternatives, are reached through communication, the Internet offers great new opportunities for enhancing transactions and their dynamics. All businesses advertise and sell either or both products and services. The present invention, and various embodiments, deals with service transactions.

The record of the development of the Internet is a record of expanding ways in which those who have services to sell can offer and transact those services to the Internet-connected world. At the time of the present patent application, there are already many Internet systems in place for offering and contracting services. Also, in most cases, the services offered our reservable; that is, one may contract to purchase such a service at a particular place and at a particular time. Some enterprises, for example, allow people to reserve tables at various restaurants on specific dates and at specific times. Others allow golf enthusiasts to reserve tee-times at various golf courses. All such systems advance consumer facility in at least a small way. Still, a great number of individual sites, each offering one or a few related services, creates a maze of difficulty for the Internet consumer.

In a transaction database handling both sellable resources and engaged resources wherein both entities are time-based, micro management techniques must be employed in order to successfully convert status indication from sellable resource to engaged resource over the entire database. For example, as available time allotted for a sellable service is used up through engagement of the service, exact status must be available at any given time. In prior art management techniques, human resources are employed to perform periodic updating through data entry and other manual data management techniques such as deleting a reserved portion of a sellable resource from the database and creating a new engagement status, which occupies the subtracted time span. When a single database is used to keep track of a plurality of disparate resources and engagements thereof, induction of human resource for micro-management purposes can lend to an unacceptable level of system errors such as double booking, incorrect evaluation of time units, and other typical mismanagement problems.

Another challenge facing an enterprise hosting a transaction system is the prospect of setting and updating pricing structures for sellable resources within the database. For example, not all same services offered by suppliers are marketed for a same price at a same time. Some third-party sellers have standardized some aspects of pricing by agreeing to pay a flat rate to suppliers for offered services in exchange for providing a marketing advantage to such suppliers through third-party advertising. This technique is especially applicable to time-based resources. Some suppliers maintain a per/hour shop or service rate regardless of the service or work performed within the sold period.

Many customers, however, are moved to purchase at certain times based on rate reductions associated with normally higher priced commodities. This fact is well known in the art and exploited in many known sales techniques. It is desired, however difficult, to integrate some of these known price-adjustment methods within automated transaction systems such that customers may be attracted to a given transaction interface for both convenience and price benefit. Moreover, workflow management may be enhanced, to a large extent, by introducing flexible or dynamic pricing capabilities to database systems.

In prior-art systems, such implementations are either human managed through continued data input (programming) or pre-programmed into a system before availing access of the system to the public. In both cases, there are difficulties related to structure in-flexibility and human induced error. For example, pre-programmed scenarios reflecting a set structure must be re-implemented when conditions or markets change, which may be often. Similarly, systems continually updated through human resource are subject to repeated error. One with skill in the art will attest to a fact that much improvement is needed in the areas of workflow and data management associated with implementing and managing pricing structures for services offered through transaction systems.

What is clearly needed is a method and apparatus for enabling automated, dynamic, and flexible price setting and management for reservables offered within a transaction database. Such a method and apparatus would enable a hosting enterprise to market in a flexible manner and smooth workflow related to creating, managing, and fulfilling transactions performed by customers over given periods of time.

### SUMMARY OF THE INVENTION

In a database-driven transaction system, a dynamic-pricing mechanism for setting prices for timebased services offered and available through an interactive interface of the transaction system is provided. The mechanism comprises a floating time window for identifying a span of time in which services are available to be engaged; an averaging function for determining an average price paid to a single or multiple suppliers of services offered; a scaling function for dividing the time window into definitive time units; and a price-adjustment function for adjusting prices paid by customers for services according to position of engagement of said services within the time window.

In one aspect, prices determined by the averaging function are paid by an entity hosting the transaction system. In the same aspect, prices adjusted by the price-adjustment function are paid to the entity hosting the transaction system. In a preferred embodiment, the prices adjusted by the price adjustment function are adjusted in a graduated fashion higher or lower depending on engaged position from a predetermined position within the time window. In this embodiment, the prices adjusted by the price adjustment function increase gradually according to engagement positions indicated serially from the predetermined position in the time window to the beginning of the time window. In the same embodiment, the prices adjusted by the price adjustment function decrease gradually according to engagement positions indicated serially from the predetermined position in the time window to the end of the time window.

In one aspect, the price-adjustment function is further programmed to make pricing adjustments according to time-of-day, day-of-week, week-of-month, month-of-year, or a combination thereof In this aspect, the programming may temporarily take the place of pricing according to position of engagement within the time window.

In a preferred application, the time-window parameters and the pricing parameters are both expressed in XML format. In variations of this theme the time-window parameters and the pricing parameters may be expressed as one of a family of SGML-based markup languages, which includes XML. In some applications, the time-window is displayable in a graphics format on a suitable display device connected to the transaction system.

In another aspect of the present invention, in a database-driven transaction system, a dynamic-pricing mechanism for setting prices for timebased services offered and available through an interactive interface of the transaction system is provided. The dynamic-pricing mechanism comprises a floating time window for identifying a span of time in which services are available to be engaged; a scaling function for dividing the time window into definitive time units; an inventory quantifier for quantifying inventory levels of available services within the time window; an averaging function for determining an average price paid to a single or multiple suppliers for services offered and a price-adjustment function for adjusting prices paid by customers for services according to an indicated level of inventory of said services quantified by the inventory quantifier and available within the time window.

In a preferred aspect, the prices determined by the averaging function are paid by an entity hosting the transaction system. In the same aspect, the prices adjusted by the price-adjustment function are paid to the entity hosting the transaction system.

In one aspect, the prices adjusted by the price adjustment function are adjusted in a graduated fashion higher or lower depending on the indicated level of inventory of said services at the time of service engagement within the time window. In this aspect, the prices adjusted by the price adjustment function increase gradually according to indication of gradually lower inventory levels as quantified by the inventory quantifier at the time of given service engagements within the time window. Also in this aspect, the prices adjusted by the price adjustment function decrease gradually according to indication of gradually higher inventory levels as quantified by the inventory quantifier at the time of given service engagements within the time window.

In preferred applications, the pricing parameters, the time-window parameters and the indicated inventory levels are expressed in XML format. In variations to this theme, the time-window parameters and the indicated inventory levels may be expressed as one of a family of SGML-based markup languages, which includes XML. In some applications, the time-window and indication of inventory levels are displayable in a graphics format on a suitable display device connected to the transaction system.

In yet another aspect, the price-adjustment function is deactivated for the purpose of conducting one of a straight auction, a reverse auction, or a Dutch auction. In still another aspect, the price-adjustment function is further programmed to make pricing adjustments according to time-of-day, day-of-week, week-of-month, month-of-year, or a combination thereof In still another aspect, the price-adjustment function is further programmed to make subsequent price adjustments according to engagement of multiple units of like inventory performed by a single customer.

In another aspect of the invention, in a database-driven transaction system, a method for determining a variable pricing structure for timebased services offered through an interactive interface of the system is provided. The method comprises the steps of: (a) averaging actual prices paid to suppliers for services according to specific time units; (b) providing a time window within the transaction system, the window dividable by the specific time units; and (c) adjusting the actual prices paid by customers for service engagements established within the time window according to a preset sliding-scale rule implemented within the time window.

In a preferred aspect of the method in step (a), the prices determined by the averaging function are paid by an entity hosting the transaction system, and in step (c), the prices adjusted by the price-adjustment function are paid to the entity hosting the transaction system.

In one aspect of the method, in step (a), the averaging function includes averaging prices set for disparate services offered by a single supplier. In another aspect, in step (a), the averaging function includes averaging prices set for disparate services offered by multiple suppliers.

In a preferred application of the method in step (c), the sliding-scale rule provides for increasing or decreasing prices depending on the position of potential service engagements identified within the time window from a predetermined position in the time window. In this application, in step (c), the sliding-scale rule dictates a gradual increase in price according to engagement positions indicated serially from the predetermined position in the time window to the beginning of the time window. In the same application, in step (c), the sliding-scale rule dictates a gradual decrease in price according to engagement positions indicated serially from the predetermined position in the time window to the end of the time window. In a variation of the above-described method, in step (a), price averaging includes the averaging of materials and labor.

In preferred applications of the method in steps (a) and (b), the expressions representing given prices and time-window parameters are XML expressions. In variations to this theme, in steps (a) and (b), the expressions representing given prices and time-window parameters may be expressed as one of a family of SGML-based expressions, which includes XML expressions. In some aspects of the method, in step (b), the time-window is displayable in a graphics format on a suitable display device connected to the transaction system.

In another aspect, the method further comprises a step (d) for providing an indication of an inventory level associated with a defined timebased service available within the time window. In this aspect, the method further comprises a step (e) for adjusting prices paid by customers according to given levels of inventory of available timebased services indicated within the time window.

In one variation of the above-described aspect, the method further comprises a step (f) for temporarily deactivating steps (c) and (e) for the purpose of conducting one of a straight auction, a reverse auction, or a Dutch auction. In still another variation, the method further comprises a step (f) for adjusting prices paid by customers according to time-of-day, day-of-week, week-of-month, month-of-year, or a combination thereof In yet another aspect of the method, a step (f) is provided for performing price-adjustments according to engagement of multiple like services by a single customer. In one aspect of the method, the price-adjustment functions indicated by step (f) may be added to the price-adjustment function indicated by step (c). In another aspect, the price-adjustment functions of step (f) may each or collectively replace the price-adjustment function of step (c).

In the embodiments of the invention taught in enabling detail herein, for the first time, methods and apparatus for providing variable price structures for time-based services available through a transaction system is provided whereby dynamic pricing is achieved without extensive human input and associated error.

### BRIEF DESCRIPTION OF THE DRAWING FIGURES

FIG. 1 is a schematic diagram of a reservables transaction system according to an embodiment of the present invention.

FIG. 2 is a block diagram of data organization and inter-relationships in a preferred embodiment of the present invention.

FIG. 3 is a schematic diagram illustrating supplier communication with the system in an embodiment of the invention.

FIG. 4a is a diagrammatical representation of system data entities according to a preferred embodiment of the present invention.

FIG. 4b is a diagrammatical representation of system data entities according to an alternative embodiment of the present invention.

FIG. 5 is an illustration of a six-week time window applied to the system database.

FIG. 6 is a flow diagram illustrating an exemplary transaction process in an embodiment of the present invention.

### DESCRIPTION OF THE PREFERRED EMBODIMENTS

Overview

In a preferred embodiment of the present intention, an Internet-connected system is provided wherein a very large number of typically small businesses may offer reservable services to an even greater number of Internet-connected consumers/clients. The invention is not limited, however, to small businesses, and applies in many embodiments to enterprise aggregates of a plurality of businesses or service providers. The number of clients (customers) is virtually unlimited, as practically everyone has, or may gain access to communication tools to interact with services of the invention. The number and types of businesses and aggregated enterprises which might participate in such a model is also essentially unlimited.

The present inventors have developed a unique system and model for facilitating transactions among such businesses and clients. In this system, a service provider may participate if the services offered can be presented to potential clients as time-associated reservable entities. The present inventors term such service entities as reservables, and this term is used throughout the present patent application.

Reservables

A few specific examples will clarify what the inventors mean by reservables. Beauty salons, considered as a class of service suppliers, will all typically employ hair stylists, that is persons with the skill and training (and perhaps licensing as well) to do hair styling. All hair stylists also may be considered to offer services within a certain broad definition of hairstyling services, including such as hair washing, permanents, and the like, and such services may be considered to typically endure for certain time durations. There are therefore global definitions that may be made for hairstyling services. A particular salon, in a particular locale, however, will employ a specific group of persons for performing hair styling services, and each of these persons will have an individual set of skills, and an individual matrix of availability. As a concrete example, Miranda Chavez may be employed by XStream Hair Salon in San Mateo, Calif., and she may offer (through her employer at the supplier's place of business) hairstyling within a specific class of styles, each session to consume a time duration of 90 minutes, and priced at $35 per session.

Given the above discussion of general service and particular services relative to resources, a reservable for the purposes of the present specification, is at the most particular level: A reservable will appear in the database of the system of the invention as, for example, a Miranda Chavez styling session, with its attendant constraints on time, nature of service, and price. And is differentiated specifically from a Barbara Turner styling session, which might appear as a reservable in the database, having a different duration, applying to different hair styles, and at a different price, even though Barbara Turner may be employed by the same supplier.

Further to the above, Miranda Chavez may be multi-talented, and enabled by skill set, license, and whatever else might be required, to do pedicures as well as hair styling. In this case there may well be reservables in the database, constrained particularly to Miranda, having a duration, a description of service content, and a price, for pedicures. By virtue of two different reservables, Miranda may be engagable for any one of several services in the same or overlapping time durations. The system of the invention is required, as customers engage services (make reservations), to amend the inventory of reservables accordingly. That is, when Miranda is engaged for a pedicure from 2:00 to 3:00 PM on a particular afternoon, she will no longer be available to do hair styling in that time frame, and the system has to amend the inventory of reservables to suit.

In some cases reservables assume another dimension, that of capacity. Consider a movie house, for example. A reservable for the Bijou theatre may be for a performance of Batman III from 2:00 PM to 5:30 PM on Sunday June 4th. The theatre seats 75, so the reservable has the dimension of capacity. The reservable continues to be available for engagement until 75 persons have signed up for the performance (bought tickets, or engaged to buy tickets). More detail is provided below regarding reservables, and how they are generated and managed in the system of the invention.

In a preferred embodiment of the present invention a reservable has new and unique characteristics. In conventional systems an enterprise may provide, through the Internet, for example, a service making reservations for the particular enterprise. There is always a strict relationship between the supplier providing the service and the customer contracting for the service. In one preferred embodiment of the present invention reservables are defined independent of suppliers: reservables can be defined, within the common framework of the inventors' exchange, to capture the characteristics of a broad range of businesses and the services they provide. One feature of the present invention that makes this characteristic possible and even desirable is the exchange nature of the system of the present invention. Over a large number of suppliers of various services, and at least an equally large number of potential customers for such services, the inventors have discovered that there is an opportunity to define and market salable services (reservables) essentially independent of suppliers.

A further example may help to clarify the nature of supplier-independent reservables. Assume, for example, that a relatively large number of suppliers of automotive services in a particular defined geographic region all have mechanics trained to do oil changes, and therefore offer oil changes as reservables. If there are several suppliers who meet the requirements of this reservable, and the constraints in the reservables are very close in nature, then the service may be offered completely independently of specific suppliers. Under these circumstances a potential client or customer comes to the exchange with a desire to make an appointment for an oil change within the bounds of a particular geographic region. The exchange presents to the potential customer from the database of reservables available to the system, and perhaps several options pertaining to location, price, and so forth, and potential customer must make a decision as to whether to contract for the service or not.

There are other unique characteristics of reservables: For example, a reservable in a preferred embodiment of the present invention may be embodied as a semi-continuous representation of the time interval over which the corresponding service is offered (available). For example, a particular barber's schedule on an “open” day (no reservations yet made) might be represented by a single reservable time interval from 10 am to 5 pm (the barber's hours). Note that a reservable is represented in a time interval, rather than a time span. An essential difference is that a time interval is finite, having a specific start and end time, while a time span is potentially infinite. A specific service request from a potential customer might at some point be accommodated for a haircut, matching all of the criteria for this particular barber, including a desire to have this haircut take place within the time interval representing the barber's reservable. An engagement transaction is made, and a new database entity is created for the engagement, including the customer, the supplier, the time, the price, and so on.

Now the system must recalculate (regenerate) the reservable inventory. The time and duration for the engagement is no longer available as a reservable for the particular barber. Let us assume the engagement made is for a haircut at 2:00 PM to last 1 hour (to 3:00 PM). The 10:00 AM to 5:00 PM interval as a reservable for this barber now becomes two intervals; one from 10:0 AM to 2:00 PM, and the other from 3:00 PM to 5:00 PM.

This implementation differs from systems which use discrete representations of service availability: for instance, the barber's availability might be represented by 14 “bins”, each 30 minutes in length, end-to-end, running from 10 am to 5 pm.

Some of the advantages of the new approach are: 1. speed of lookup (fewer reservables to consider), 2. flexibility and efficiency (no need to decide ahead of time how time should be broken up, more opportunity for optimization/filling gaps), 3. accuracy (can accommodate to-the-millisecond “granularity”, which would be impossible to represent in reasonable space/time with a discrete system which would have to generate 25,200,000 millisecond-long bins for this single 7-hour day).

This is not to say that the instant invention is limited to the kinds of time interval reservables defined immediately above. In the instant invention discrete reservables may be used instead of, or in conjunction with interval reservables, and, in some cases, reservables may be created on-the-fly as requests are made.

The services hierarchy, to which reservables are associated, is important as it helps to enable search features that are described above. The services hierarchy is in general a system for classifying services by type and region. For example, there may be a high-level category for automotive repair services, which is subdivided at a lower level into top and body repair, engine repair, transmission repair and replacement, lubrication services, and so on. Individual ones of these lower-level categories may be further divided into a more granular matrix. Engine repair, for example, can be further categorized into foreign and domestic models. Although reservables may be, in special cases, supplier-independent, they can also be extended to capture particular properties for some suppliers. For instance, reservables might have a notion of “capacity” to represent a movie (for example): each ticket sold to the movie would decrement 1 unit of capacity from the reservable, until it's capacity reached 0. The dimension of capacity in reservables extends to many cases, such as restaurants (# of tables and seats), theatres and the like, and to any situation where more than a single customer may be accommodated in a service simultaneously.

Engaged Reservable (Engagement)

An engagement, in a preferred embodiment of the present invention, is in many cases quite similar to what is commonly known as a reservation. In this sense, a customer, taking advantage of the system to arrange for a service to be performed, after some negotiation with the system, transacts with the system to engage, or reserve, a service to be performed at a particular time and place, and typically at a particular price. In most cases the engagement is supplier-specific; that is, the customer transacts to receive a service to be performed by a resource associated with a particular supplier. As an example, a barbershop may have several barbers (resources) available to do haircuts at particular times, and the customer, in the transaction, agrees to receive a haircut from one of the barbers at a particular time, on a particular date, at a particular price at a particular place, usually the premises of the barbershop (but certainly not always so). In some cases, for example, the barber service may specialize in outservice haircuts, and the barber will come to the location of the customer to perform the service.

Following the concept of supplier-independent reservables in one preferred embodiment, engagements may also be supplier-independent. That is, a customer, visiting the service exchange in an embodiment of the present invention, may engage a reservable without being matched with a specific resource or supplier. This is quite different from a conventional reservation, because, at the time of contracting for the reservable, the customer does not know where and how to take delivery of the service contracted, that is, the engagement. In this interesting case, the enterprise hosting the exchange has an option over a reasonable time window of selecting among several suppliers having resources capable of fulfilling the requirements of the engagement, and even of soliciting suppliers to fulfill engagements already made. Further examples of such supplier-independent reservables and engagements are described in more detail below.

System Architecture

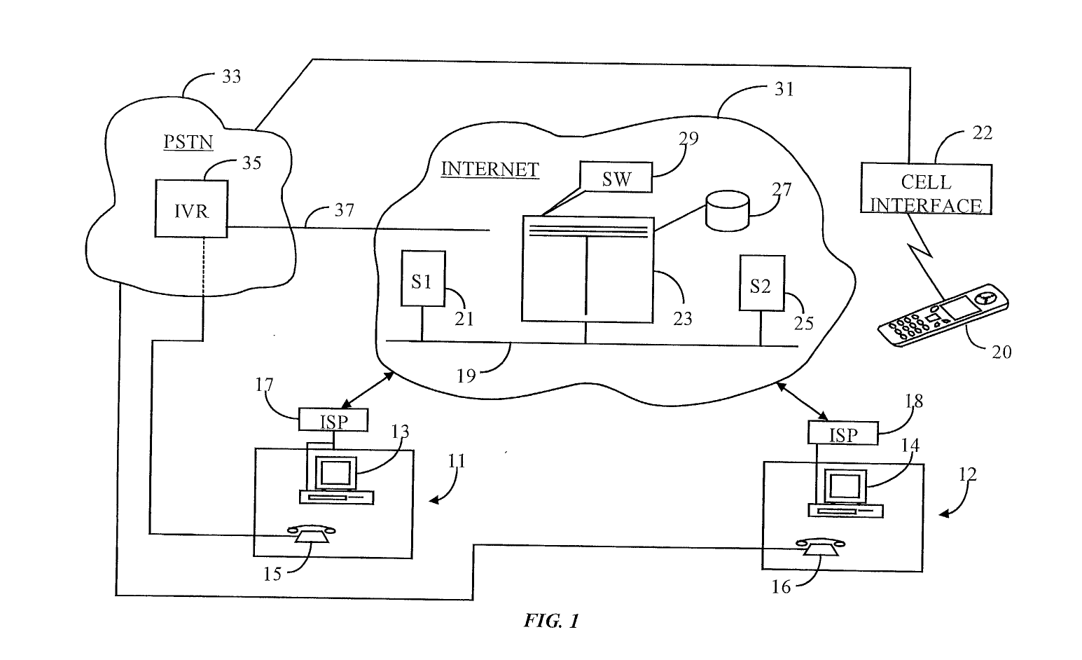

FIG. 1 is a schematic diagram of a system according to a preferred embodiment of the present invention. FIG. 1 illustrates a client station 11 having a personal computer (PC) 13 and a telephone 15. A personal-computer such as PC 13 in a home is a typical way in which a person may access and browse the Internet. The skilled artisan will recognize and understand that such a PC is but one of many ways a client may access the Internet network. At the time of the present patent application there is rapid growth in the use of handheld devices for Internet access. Such devices include personal organizers, cellular telephones, handheld computers, and several other devices. PC 13 in FIG. 1 is therefore meant to represent all of the many Internet appliances that may be used to access and browse the Internet, except the case of Internet access by cellular telephone, which is represented in FIG. 1 by telephone 20 acting through interface 22.

PC 13 is shown as connecting through an Internet service provider (ISP) 17 to the Internet network represented by cloud 31. The skilled artisan will also recognize that there are a number of ways that Internet appliances may connect to the Internet network. Computerized televisions, WEB TV, for example, may connect through cable modem. Some handheld devices are now available that connect in a wireless fashion. Cellular telephones always connect, if Internet-enabled, wirelessly. Also, devices connecting by telephone modem may do so through a standard analog line, and integrated services digital network (ISDN) line, or a high-speed digital services line (DSL). The connection of PC 13 to Internet cloud 31 through ISP 17 is therefore meant to represent all of the conventional ways Internet appliances may connect to the Internet.

Backbone 19 shown in Internet 31 is meant to represent all of the interconnectivity in the Internet. Two servers, server 21 and server 25 represent the great number of Internet connected servers that are accessible by the public. A particular transaction server 23 is hosted by an enterprise providing reservable transaction services according to an embodiment of the present invention. Transaction server 23 has access to a data repository 27, which, in a preferred embodiment, contains a sophisticated database according to embodiment of the present invention. Transaction server 23 also is enhanced by a software suite 29, which represents unique software according to embodiments of the present invention.

Client station 11 in FIG. 1 also is shown as having a telephone 15 which connects to a public switched telephone network (PSTN) 33. Telephone 15 is capable of reaching all destinations in PSTN 33, including an interactive voice response (IVR) system 35, which, in the embodiment described with reference to FIG. 1, is associated with transaction server 23, and hosted by the same enterprise that hosts transaction server 23. IVR 35 is shown as connected to transaction server 23 by a communication link 37. The skilled artisan will recognize that there are a number ways this communication may take place. Link 37 may be an optical link, a high-speed land-line, a wireless link, or the link may be accomplished by a (typically secure) Internet connection to backbone 19. There are a variety of possibilities. Unique functionality of the system including transaction server 23 and IVR 35 is described in plural aspects and in enabling detail below.

In addition to the above, access to server 23 may also be made by cellular telephone. A single cellular telephone 20 is illustrated in FIG. 1 as connecting wirelessly to a cellular interface 22, connecting conventionally to PSTN 33. The skilled artisan will be aware that block 22 represents all off the equipment and connections that are known in the art for communication by cellular telephone. Also that the single telephone 20 represents the ability of customers and suppliers to interact with the system of the invention by cellular telephone.

Also shown in FIG. 1 is a supplier station 12, quite similar to client station 11. A supplier, in a preferred embodiment of the present invention, is quite different from a customer. The supplier, for example, is typically a small business that contracts with the hosting enterprise to offer services as reservables. The means by which a supplier communicates with the exchange hosted on server 23, however, is essentially the same as the means by which customers communicate with the exchange. In FIG. 1 supplier station 12 is equipped with a PC 14 connecting via modem through an ISP to Internet backbone 19 and thence to server 23. Station 12 represents all suppliers contracting with the service at server 23. Supplier station 12 also has a telephone 16 connecting to PSTN 33. It will be apparent to the skilled artisan that the arrangement shown is exemplary, and supplier communication with server 23 might be accomplished in a variety of other ways.

Data Structures and Interconnectivity

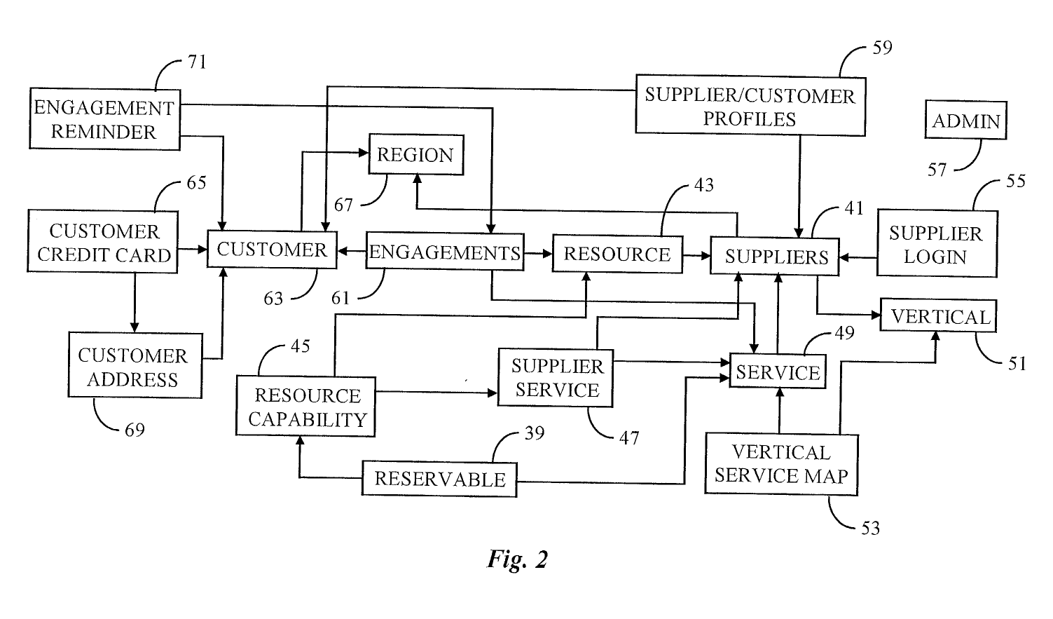

FIG. 2 is a block diagram of data structures and interrelationships in a preferred embodiment of the present invention. The database structure in preferred embodiments of the present invention is unique in that inventory which is added and marketed through the transaction service by service suppliers is defined and organized as reservable entities. In general a reservable is a data record defining a capability for performing a specific service by a specific resource over a particular time interval, as described above. The present Inventors are aware that database operations are not particularly efficient when looking for entities that do not exist (their nonexistence can only be determined by examining the result of inverting all positive entities). In a conventional operation providing reservations to clients or customers, the positive entities are the scheduled reservations or appointments, rather than those potential appointment not yet made. Yet it is a potential appointment not yet made that a customer will be shopping for, and thus that the database will be searching for. The Inventors have solved this efficiency problem by defining the salable inventory as positive data structures called reservables, separate from reservations. At the point that a customer contracts to purchase a reservable, that reservable becomes an engagement (a reservation) (a “negative” entity).

As described briefly above, the system of the present invention in one preferred embodiment, embodied in one or more transaction servers, such as server 23 of FIG. 1, functions as an exchange between service suppliers and customers for the services supplied. In this aspect there would be many suppliers of services and many customers. In another aspect of the invention the system could be hosted and operated by a single host/supplier, such as a company like Midas, which markets services in automotive areas, such as exchanging old mufflers for new; or by a company like Budget, which provides rental cars for which customers make reservations. This single business might offer many geographically disparate service providers to customers, each representing individual members of its franchise or chain, and each may operate with varying degrees of autonomy (both within the system and in its actual business practices).

The present inventors, in developing the system of the invention in preferred embodiments have provided numerous innovative structures and techniques, many of which, in alternative embodiments, may be provided as separate and unique business-to-business services. These innovative structures and techniques are described in enabling detail herein and below.

Referring now to FIG. 2, as an overview of the database in a preferred embodiment of the present invention, organized by data structures, reservables 39 represent the inventory of time-based entities (services) offered for reservation and sale, as described above. Reservables are calculated (instantiated) by a unique time-line algebra in preferred embodiments of the invention, from unions and intersections of other data structures, in particular from such as resources, suppliers, resource capabilities (skill sets), and service definitions. Specific suppliers having certain fixed and variable resources may contract with the exchange in a preferred embodiment of the present invention. The suppliers contracting with the exchange are listed and identified as data structures 41, labeled suppliers. Typically, each contracting supplier is identified by such characteristics as full name, at least one address, city, state or province, a country code, a postal code, a vertical key, determining to which vertical services industry the supplier's business may be classified, a region key, determining the geographic region of the supplier, certain other properties, and a flag for availability. Data structure 41 identifying suppliers is implemented in the database in a formal manner in which some, but perhaps not all, of the characteristics described may be required. In some embodiments, as described above, there may be but a single supplier to whom all resources are associated.

Another data entity and structure defined and useful in a preferred embodiment of the present invention is that of a resource, recorded in data structure 43. A resource differs from a supplier in that a resource may perform or be used typically for one service at a time, and when in use is typically not available for any other use, or when engaged for some future use is not available for engagement at the same time by another customer. For example, a person may be a resource, such as Sam the mechanic who does oil changes. When Sam is engaged in changing your oil, he cannot be engaged in changing my oil, and when Sam is committed to change my father's oil next Thursday at 2:00 PM to 2:30 PM he cannot be available to be engaged by another for that or another service in the same time interval. Further, an object may be a resource. For example, a service bay in which Sam the mechanic may perform oil changes, may also be considered a resource for purposes of embodiments of the present invention. Any supplier may provide a broad range of services utilizing individual resources.

In some cases the idea of a strict application of resources may be loosely enforced. For example, under some conditions, overbooking may be practiced. This would be done in situations of a supplier having a relatively large number of resources, and a clear history of no-shows. Such controlled overbooking is a function of yield-management, which is a service of the system to certain registered suppliers under controlled circumstances. In other cases, it is conceivable that some resources may be capable of multitasking. It is well-known, for example, that a hairdresser may be working with one customer while another is under a dryer, and so on. There are many other possibilities of multi-tasking in service industries, and the system of the invention accommodates this concept.

Every resource has specific capabilities and uses, and these capabilities are recorded as a separate data structure 45. Each resource capability 45 is tagged in a preferred embodiment with the resource ID and supplier service ID, and is characterized in the data structure by one or more of availability, duration, cost, duration max, duration min, duration interval, and perhaps a textual description. A single resource, it should be noted, may have, if a person, a relatively wide range in skill set, and may therefore be capable of performing a relatively broad range of services. A resource capability represents one such skill of such a resource.

Data structure 47 represents supplier services. A supplier service is defined as a service that is provided by one or more resources associated with a particular supplier. An example is an oil change that may be provided by Sam the mechanic. Supplier services will in many cases be instances of global services (or simply “services”), meaning that an oil change may be provided by resources associated with several different suppliers. In other instances a supplier service may be specific to a single supplier, and therefore proprietary. Whether a supplier service is an instance of a generic service or specific to the supplier is determined by a serviceID associated with the supplier service. Note that a service, however specific, is not a reservable, but merely a description of actions that may be performed with and by resources for a customer.

Another data structure, labeled service 49, represents the global services defined by the hosting enterprise. These services are always global, such as dinner, an oil change, or a haircut. A particular use of the global service data structure is in classifying services offered by suppliers to become inventory as reservables, so that the customer may readily search for available service inventory across suppliers. These service definitions remain fixed over relatively long periods in the system, but are not invariable, as the hosting enterprise will rely on the suppliers to further define existing services and even to invent new services from time to time.

Yet another data structure 51, labeled vertical, is a vertical map, which identifies an industry category of services that are identical or very nearly identical. Tagging services with a vertical key is advantageous in limiting searches made, for example, on behalf of customers looking for certain kinds of services, generally provided by similar types of businesses. Another data structure 53, labeled vertical service map, combines service ID from structure 49 with the vertical key from structure 51.

Data structure 55 labeled supplier login, is a data structure specifying the format for login accounts of contracting suppliers. A data structure 57 identifies support persons, such as knowledge workers, who may be authorized to enter and amend various information in the database. Another data structure 59, labeled supplier/customer profile, is a structure allowing the hosting enterprise to store and access information about customers that is specific to particular suppliers and which may be used to offer those customer priority service, discounts, special pricing, and so forth at those suppliers. In the exchange model this data structure may also profile suppliers, and many services made possible by the unique aspects of the present invention depend upon information developed on both customers and suppliers and stored as profile information.

Data structure 61, labeled engagements, represents engagements made by customers against reservables. Each reservation data record is enhanced by information completely identifying the engagement, such as Customer ID, resource ID, supplier service ID, start time, and end time, and other information such as properties, party name, contact phone, and special requests. It will be apparent to the skilled artisan that not all of the information is strictly required, and in some cases other information may be required.

Data structure 63 identifies to some extent each customer transacting with the exchange or with the single host of the service. This data structure includes information such as full name, given name, surname, nickname or alias, phone number, region key, login name, e-mail address, and in some cases other information. Structure 65 stores details of customer credit cards for charging against reservations made. Credit card information includes such as nickname, card number, expiration date, full name, customer ID, and address ID.

Data structure 67 is for defining geographic regions in which services may be offered. It will be apparent to the skilled artisan that there is a broad variety of ways regions may be structured. In general regions in preferred embodiments of the present invention are structured reasonably for customer physical access to services. Data structure 69, labeled customer address, is for storing customer addresses, including at least street address, city, state or is specific to particular suppliers and which may be used to offer those customer priority service, discounts, special pricing, and so forth at those suppliers. In the exchange model this data structure may also profile suppliers, and many services made possible by the unique aspects of the present invention depend upon information developed on both customers and suppliers and stored as profile information.

Data structure 61, labeled engagements, represents engagements made by customers against reservables. Each reservation data record is enhanced by information completely identifying the engagement, such as Customer ID, resource ID, supplier service ID, start time, and end time, and other information such as properties, party name, contact phone, and special requests. It will be apparent to the skilled artisan that not all of the information is strictly required, and in some cases other information may be required.

Data structure 63 identifies to some extent each customer transacting with the exchange or with the single host of the service. This data structure includes information such as full name, given name, surname, nickname or alias, phone number, region key, login name, e-mail address, and in some cases other information. Structure 65 stores details of customer credit cards for charging against reservations made. Credit card information includes such as nickname, card number, expiration date, full name, customer ID, and address ID.

Data structure 67 is for defining geographic regions in which services may be offered. It will be apparent to the skilled artisan that there is a broad variety of ways regions may be structured. In general regions in preferred embodiments of the present invention are structured reasonably for customer physical access to services. Data structure 69, labeled customer address, is for storing customer addresses, including at least street address, city, state or province, country code, postal code, and contact phone. Regional compartmentalization is very useful for efficiency purposes in many aspects of the present invention. Typically, for example, a person (customer) shopping for a new muffler will want to transact with a supplier in the same town or general area as his/her home. This is not a strict limitation, however, because travelers may certainly wish to engage services along the routes of their travel, which may be extensive and global in nature.

Data structure 71, labeled engagement reminder, stores data entities relative to engagements, and is provided to generate reminders (alerts) for customers of contracts (engagements) made to use services of suppliers in the exchange, or of the supplier in the single-host model. Reminders may take the form of an email, an automated phone message, a fax, a pager message, and so on. Information includes such as reservation ID, customer ID, reminder time, and type. Reminders may be escalatory in nature as well, with repeat reminders spaced more closely and expressed with increasing urgency.

The interconnecting arrows in FIG. 2 indicate interrelationships between the various data types and structures. Given the set of data structures described with reference to FIG. 2, and suitable control functions and software described in enabling detail below, reservables are created (instantiated) in an ongoing fashion from unions and intersections of other data entities, customers may be efficiently and quickly matched with resources associated with contracting suppliers, and a variety of pre-and post reservation services may also be provided. It should be remembered, as well, as described above, that in some cases engagements may be made by customers with specific suppliers, and in some cases engagements may be contracted between a customer and the enterprise hosting the service exchange in an embodiment of the invention. In the latter case, the engagement is supplier-independent, and the enterprise hosting the exchange has latitude in specifying a supplier after an engagement is contracted with the customer. Supplier-independent reservables and engagements are not denizens of single-host systems.

In some cases, after an engagement is made, the consummation is left up to the supplier and customer. In other cases, however, the system, having detailed knowledge of all engagements, may offer and provide alert services, reminding customers of engagements. Such reminders can take a variety of forms, such as e-mail, automatic facsimile, telephone reminder, pager service, and so forth. Reminders and alerts may also be provided on an escalatory basis, so that a customer may be reminded of an engagement at one point in time, and then again at a time closer to the scheduled time of the engagement.

Inventory Development

As has been described in some detail above, the system of the present invention in a preferred embodiment comprises an exchange wherein customers may contract for services represented as reservable entities associated with specific suppliers, and in other embodiments in a supplier-independent manner. Reservables in the system are relatively rigidly defined and are calculated regularly from other data in the system to become reservable data structures in a time-based inventory. It is, of course, necessary to develop the inventory to have anything to sell to customers. And, since the reservables are functions of service definitions, suppliers, resources, resource capabilities, and the like, these entities must be generated to develop reservable inventory.

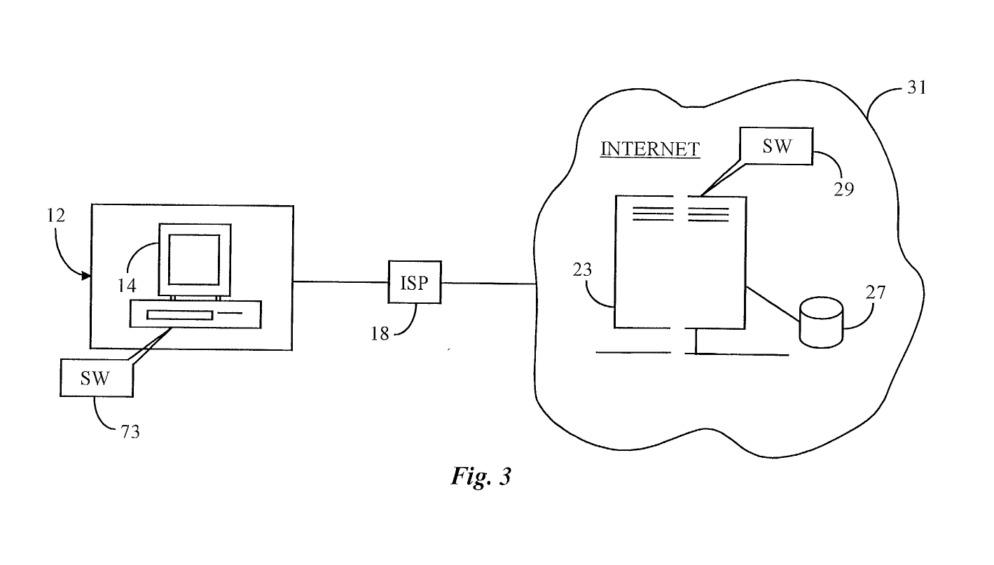

In a preferred embodiment, considering the multiple-supplier exchange model, there are a variety of different ways in which business enterprises which wish to participate may do so. One method provided by the system of invention is through a browser interface. FIG. 3 is a schematic drawn from FIG. 1 of supplier communication with the system for creating a supplier relationship with system, and for such other tasks as defining and posting reservables with the system. In this arrangement a supplier may interact with the system on server 23 by means of PC 14 at supplier station 12, establishing connection to the Internet 31 via ISP 18. The skilled artisan will be aware, again, that the schematic is representative of all of the conventional means by which a supplier may accomplish Internet connection.

In one embodiment interaction by a supplier with the exchange-model system is via a conventional browser, which is represented in FIG. 3 by software 73. In the supplier interaction server 23 provides an interactive interface by virtue of software 29. In this environment the interactive interface may be a Web page, the Web page having interactive communication input mechanisms whereby the potential supplier may become familiar with the requirements of the system, and may provide needed information to become a registered supplier. In other embodiments supplier interaction with the system may take place in other ways, such as, for example, by mail or by telephone, such as through a telephony call center, wherein the customer may interact in some cases with live agents, and in other cases with automated interactive voice response (IVR) systems.

Referring again to FIG. 2, there are a number of data structures that relate directly to suppliers. For example, structure 41 labeled suppliers, structure 55 labeled supplier login, service 49, supplier service 47, resource 43, resource capability 45, and reservable 39. In the interaction represented by the arrangement of FIG. 3 a supplier may structure a contractual relationship with the system, and provide all of the information needed for populating the data entities that the system needs to periodically instantiate reservables from the other data structures.

No attempt is made here to illustrate a design for a graphical, interactive interface, because the mechanisms of such interactive interfaces are notoriously well-known in the art. Instead, the process of the supplier interaction with the system is described below in some detail.

A first step in a supplier relationship in the exchange model is for the supplier to register with the system. This registration is a process of the supplier providing information to the system, and the system validating and recording the information. Referring again now to FIG. 2, this first step in registration is associated with data structures 41, labeled suppliers, and supplier login 55. In the process of supplier registration a potential supplier is asked to provide identification information such as full company name, at least one address, city, state, state or province, a country code, a city code, postal code, and perhaps various other information. The system may, for example, require background information such as financial health, banking information, and such things as maps and the like which may be needed for customers to take advantage of offered services.

Once a supplier is registered with the system, that supplier is assigned (or may choose) a supplier name and a password, which typically become a part of data structure 55 labeled supplier login.

Once a supplier is registered with the system, and the enterprise hosting the system has validated and authenticated the supplier, the supplier becomes a part of the system. It will be appreciated that, once a supplier is registered, it will be necessary to perform regular and periodic updates, both from the host system's side, and from the supplier's side.

It is now necessary to define what the supplier can and will supply, and this definition can take place quite neatly without creating a reservable. An important ingredient in defining supplier services is, referring again to FIG. 2, is data structure 49, labeled service. Data structure 49 is typically a global service definition provided solely by the system. There may be a relatively large number of global services 49 defined by the system. These define many kinds of services that may be offered eventually as reservables by the system in a completely supplier-independent manner, and also serve to guide suppliers in defining the kinds of services they may offer through the system. These global services are services with definitions agreed to by the system and by individual and specific suppliers. For example, dinner for four, two in a hot tub, a man's haircut, or a hairstyling session. In one aspect of the invention suppliers may agree to supply certain services according to the global service definition. In another aspect suppliers may define more proprietary services. In yet another aspect the system, having access to a number of suppliers, has the option of creating reservables, against potentially significant demand, without having those reservables associated with a specific supplier. These are the supplier-independent reservables described in some detail above. In this context it is helpful to contemplate that the kinds of services that businesses supply are not generated by the resources, but are pre-defined. That is, a particular business seeks to be a provider of a certain kind of services, and typically seeks and engages resources to be able to provide such services.

Suppliers will further provide information to the system allowing the system to create reservables based on supplier-specific capabilities. Reservables that are specific to a particular supplier and resource can also be queried independent of that supplier and resource, by way of the inherent association of those reservables with a global service. Thus, the system may allow consumers to broadly search for engagements by scanning reservables that are independent of supplier or which are actually specific to suppliers, or potentially both types of reservables, without necessarily exposing this detail to the end user. This includes data structure 43 of FIG. 2, labeled resource. A beauty shop, for example, may have four hairdressers, each of which may be entered in the system as a resource. A resource is listed with a name, availability, and perhaps a policy indication. A resource need not be a person, however, and may be an object or location. As an example, a resource may be a fully equipped hairdresser's station. Referring now to data structure 45, labeled resource capability, this data structure may be imputed based upon supplier resources. For example, the capability of hairdressers, as described above, may be limited by the availability of equipped stations, which are also resources. In other instances resource capabilities are entered by suppliers against explicitly known (and controlled) resources.

Typically a supplier, in a preferred embodiment of the present invention will be prompted to provide additional information such as availability of resources with respect to time. It may be, for example, that a particular beauty shop as a supplier may have a schedule of being open only on weekdays, and never on weekends. It may also be true that certain hairdressers employed by the particular beauty shop are available only on certain days, or only at certain times of certain days. The same beauty shop may have service people trained to do manicures and pedicures as well, and these personnel may be available on different schedules than the hairdressers. Nevertheless, given a good definition of the supplier's standard hours of operation, all the resources of a supplier, and on the availability and capability (skills) of all the resources of that supplier, the system can create (instantiate) reservables associated with all of that particular supplier's resources and services over a specific time window.

Further, given the information provided as described above relative to the resources and availabilities of a supplier, the system may look to the supplier as a provider for supplier-independent reservables. It will be appreciated by the skilled artisan that there is very great variety of suppliers that may be represented in the system. Only a relatively few examples have been given.

Referring again to FIG. 1, a generalized customer connection to the system is illustrated by customer station 11 connecting to Internet 31 through high ISP 17. It was described above that this illustration is meant to represent all of the different ways that a customer might connect to the system in an embodiment of the invention.

A customer, in preferred embodiment of the present invention, may connect and interact through a Web browser, interfacing to the system through Web pages provided by server 23. Again, as in the description of supplier interaction above, the mechanisms for such interaction are notoriously well-known, and it is not necessary or germane to the invention to describe such interactive interfaces in detail here. The interface the customer sees, however, will be very different than the interface seen by a supplier. The skilled artisan will appreciate that the customer interface may be nearly the same whether the system is of the single-supplier or the exchange model.

There are a broad variety of ways reservables may be presented to potential customers. A customer may, in one embodiment, be presented with a graphical interface allowing the customer to select among different classes of services available. In an alternative embodiment a customer may simply be asked to specify an interest, which might be done through an editable field or a graphical element such as a drop-down menu, or an icon. There are many possibilities. It is simply required that the customer be able to communicate an interest in a service to the system, and that the system, in turn, be able to present candidate reservables to the customer for consideration. The interactive interface necessarily also includes a way for the customer to negotiate in some instances, and to select from offered reservables, that is, make an engagement. It will be appreciated that, in general, the customer interface will be a bit simpler for the single host model.

In one aspect of the invention a customer may be what is known in other arts as a walk in. By a walk in in this sense, is meant a customer who visits the system on-line, but is previously unknown to the system, rather than a person who walks into one of the suppliers' premises. This is a customer previously unknown to the system, who is welcomed, and selects to make an engagement from the inventory of reservables presented by the system. In this case it is typically necessary for the system to validate the customer, at least to some extent. There are a number of ways this may be done. In one philosophy (and embodiment) the system may automatically validate a new customer for a first transaction, based on a more extended validation to be done in the interim between the engagement transaction and the actual delivery of the engaged reservable to the customer, which is, because of the nature of the time-based inventory, to be delivered at some time future to the engagement transaction. In this extended process, contact information will have been elicited from the customer, such as telephone, address, e-mail address, employment, credit card(s) (structure 65, FIG. 2), and so on; at least a subset of such information. The customer will have been entered in the database (structure 63, FIG. 2), at least temporarily.

In the interim period, a subset of SW 29 (FIG. 3) does checkups on the customer information, and validates or invalidates the customer. In this process there may be automated or manual re-communication with the customer for further information or to clarify information. Once the customer is validated a status change is made in the customer data structure for the specific customer. This status may indicate that the customer is no longer temporary, and later, after an engagement and payment history is established, may provide more granular status as to customer profile. This feature of the invention is enlarged upon in more detail below.

In another aspect, a procedure may be established for customers to enter the system and be validated before making engagements, and an entry point to such a procedure is, in one embodiment, enabled through a hyperlink on the interface page that a browsing potential customer encounters.

Two distinctions are made. Firstly, the system distinguishes between known/authenticated (“online”) customers and unknown/unauthenticated (“offline”) customers—a supplier may only want to accept reservations (engagements) from known/authenticated customers, while another may not require authentication. Note that the credential required for authentication may vary, as mentioned above in the description of customer validation, and can be configured by supplier. One supplier might require the email address of the customer have been validated, for instance, while another also requires a valid credit card. The system handles both types of customers and suppliers, and remembers which customers have (not) been authenticated. Secondly, real walk-ins may be directly visiting a supplier, and more generally fall into the category of engagements entered into the system by the supplier on that customer's behalf. Again, the system is able to automatically determine if a customer is known and authenticated and establishes the appropriate relationship between the new engagement and the online customer—or, if the customer is not known, associates the engagement with an offline customer (which may include name and other contact info but for whatever reason is not authenticated. There may not be sufficient time for this if the customer is at the business' premises.

The notion of customer listing, validation, and authentication is a very important ingredient in the present invention. The present system, both for suppliers in the exchange model, and in the single-host model, has a real capability to become a broad-based tool for business strategy and management, and knowledge of customers is a critical ingredient. Many services bearing on strategy, management, yield and the like are described further below, and most bear to some extent on customer profile.

One of the bits of information that the system derives from customer interaction is regional inclusion. Typically the system, depending on geographic extent, will operate at least partly through regional indexing. From each customer's address or postal code, for example, the system may classify the customer as domiciled within one or another system-defined region. The customer's region may have important effect in presentation of reservables to any particular customer for engagement transaction. The regional classification applies also to suppliers, and through supplier region to a region index for certain reservables in the system. It will be appreciated by the skilled artisan that not all transactions by customers for services from suppliers will be for services to be performed in a region common to both the supplier and the customer. In many cases this will be so, but there is also the case of, for example, the business traveler preparing an itinerary for a trip. This customer may be traveling from his/her home base in California for a series of meetings in New York City, for example, and may wish to contract for services while in New York city. This sort of more global, and even International matching of services to customers can be much more sophisticated than these simple examples, and is one of the premier advantages of such a system. A customer authenticated by the system of the invention may then be authenticated to a broad range of suppliers on a global scale. Suppliers may be similarly qualified for the confidence of customers.

Database Implementation and XML

There is much more to be disclosed and taught in the present specification relative to inventory development, presentation, transaction, and the like, and more such detail is provided below. The further description, however, will benefit from a discussion at this point of database implementation, of the nature of data structures, and particularly of time-related entities, which may be either time spans or time intervals. In a preferred embodiment of the present invention certain database objects may be expressed in Extended Markup Language (XML), which is a network-related computer language notoriously well-known in the art. There are a number of good reference publications available to the skilled artisan covering the subject of XML, as well as a wealth of information available on the Internet on the subject. The skilled artisan will have no difficulty reviewing the details of XML.

Timespan Treatment and Timespan Algebra

Database technology is a well-developed science in the computer arts, and much is available in the art as to how data entities may be stored, retrieved, and manipulated. For example, at a granular level, data in a digital repository is typically stored as binary strings (words in addressed locations). The size of a data repository may then be defined as a specific address space. At a higher level, data entities may be expressed as JAVA objects in a standardized manner well-known in the art, and certain functions lend themselves to such definition and expression. The present invention makes use of these and other known protocols and techniques in several aspects.

The present inventors have noted that there are particular advantages, in such as data transmission, for example, in representing certain entities as XML strings. Among these entities are the records described above that may be expressed as potentially infinite time spans. In a preferred embodiment many such records may be expressed for certain purposes as XML strings. The system, for example, converts customer requests to XML expressions, and also expresses many database entities at some point as XML strings. The skilled artisan will recognize that the software of the invention may covert between XML and other sorts of expressions.

A timespan in a preferred embodiment of the present invention represents a potentially infinite set of time intervals, the time intervals defined as half open so as to not logically overlap.

Reservables, and other time-dependent records, in a preferred embodiment of the present invention, are manipulated in context of a set theory of timespan algebra, described in some detail below. This algebra is used for several functions in operation of the system of the invention in several embodiments, such as to determine, for example, if a reservable intersects with and contains (completely overlaps in time) a customer reservation (engagement) request, indicating that the reservable is a candidate to fulfill the request.

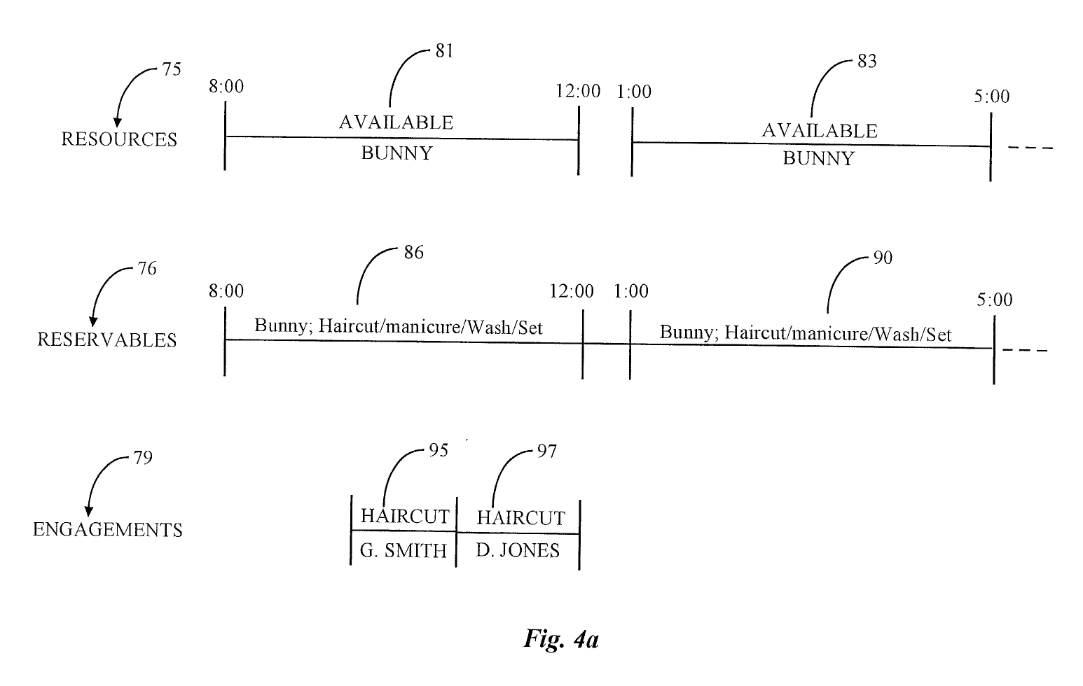

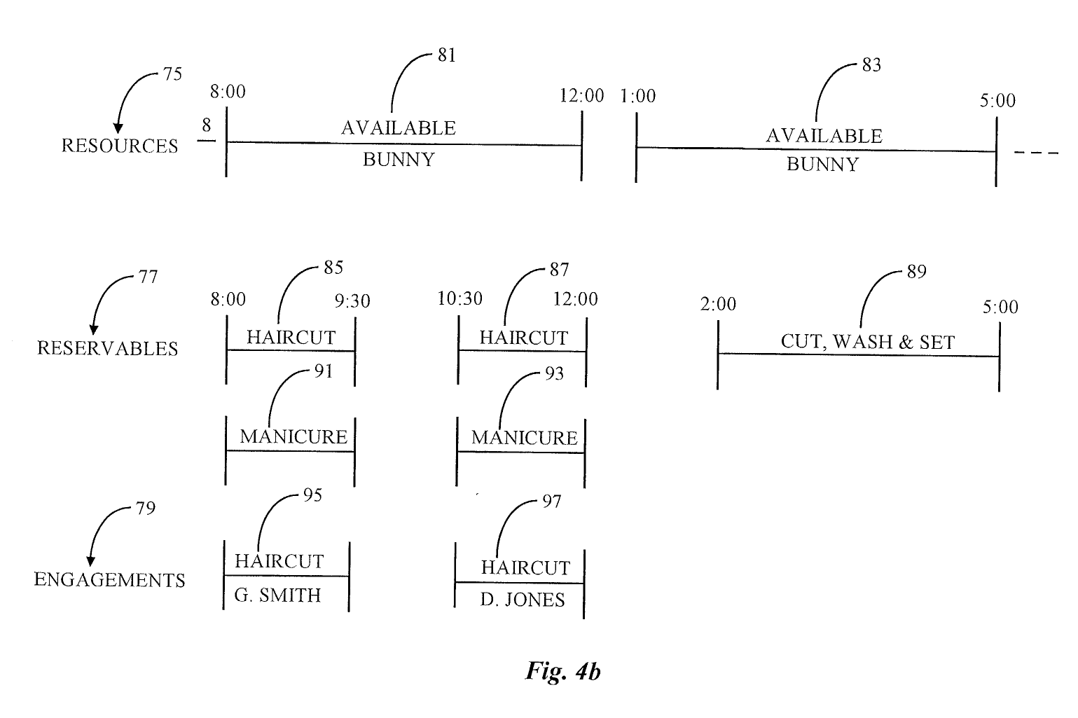

Timespans may be established and used for any of several kinds of data records that are time-based. FIG. 4a is a schematic of some relatively simple timespans according to a preferred embodiment of the present invention, that may expressed as timespans in XML format. In FIG. 4a timespans with individual time intervals are shown for resources 75, reservables 77, and engagements 79.

Timespan 75 for resources shows two time intervals 81 and 83 for a resource Bunny, who, in this embodiment is a worker in a hair and nail emporium. Bunny is shown as being available from 8:00 am to 12:00 pm and from 1:00 pm to 5:00 pm on a daily basis. This availability for a resource such as Bunny is stored in XML as a database entity in a manner to be described in more detail below, wherein one record may describe availability for Bunny over a potentially infinite time span in a relatively simple expression that describes the two time intervals shown.

Timespan 76 in FIG. 4a for reservables illustrates two time intervals 86 and 90. In interval 86 Bunny is illustrated as being available for haircuts, manicures, washes, and sets from 8:00 AM to 12:00 PM. Time interval 90 illustrates Bunny as available for the same services also from1:00 PM until 5:00 PM. This reservable may be represented as an XML expression. Certain time-varying properties of the resource and service may also be associated with reservables and captured in the XNL expression, such as service cost if the supplier is implementing dynamic pricing (explained in detail below). The formula for time-varying properties are defined in the resource and/or resource capability, and regularly updated (e.g., nightly) across all generated reservables to ensure the values are accurate. This allows rapid search by time-varying properties, like price, without having to recalculate the current price for each reservable for each search. Even though timespans by definition may be infinite in extent, reservables are never infinite. If they were, and they are the inventory in the system described and taught herein, the database to store them would also be potentially infinite. Reservables always have a definite start and end point in real time. The skilled artisan will recognize that there will be, in a typical system practicing the present invention in any of its several aspects, very many more reservables than those illustrated in FIG. 4; but the few shown are considered by the inventors to be adequate for description. In another embodiment, the compound reservable for Bunny might be represented as four separate reservables, one for Bunny haircuts, one for Bunny manicures, and one for Bunny washes, and one for Bunny sets.

Timespan 79 in FIG. 4a illustrates engagements in the system. Engagements are the recorded reservation transactions made by the system on behalf of customers. In the embodiment represented by FIG. 4a, as a simplified example, a customer in communication with the system may be seeking a haircut and may specify 10:00 AM as a preferred time. The system, consulting vertical and regional mapping presents the best matches of reservables to the customer's request.

In a preferred embodiment a unique time-span algebra described more fully below is employed by the system in searching, selecting, and presenting, and also in instantiating reservables from other database entities. In this algebra, the customers input is expressed in XML terms, reservables from the database are expressed in XML terms, and the algebra is employed to find intersections with reservables.

The customer (G. Smith) in the end selects a haircut from Bunny for 10:00 AM on Tuesday (day not indicated in FIG. 4a), resulting in engagement 95. The system records the engagement transaction, and stores the engagement (reservation). A range of date is associated with the engagement, such as the customer ID, the supplier ID, the resource ID, the day, the time, and so forth.

There are a number of other services which may be provided by the system following the transaction initiated by a customer selecting a service. Among them are informing the supplier (and the resource through the supplier) of the transaction, and alerting the customer at some time before the service is to be performed. There may also be various accounting services as a result of pre-arrangement between the system and either or both of the supplier and the customer. A second engagement 97 for Bunny at 11:00 AM for a haircut for D. Jones is also indicated in FIG. 4a.

An important feature in this embodiment is that services that Bunny may perform at any time during a specific time widow within which the system is working may be (before an engagement is made) represented by a single XML expression. The first engagement made necessarily breaks the time span of a reservable into two pieces, each of which may be represented by a separate XML expression. After an engagement transaction the system simply represent the two unbroken pieces of the original timeline by two new XML expressions as reservables. The skilled artisan will realize that the reservables are not necessarily stored in the database as XML expressions, but in forms that may be converted in either direction. A second engagement 97 breaks one of the two reservables into, again two more reservables (now there are three). This unique representation provides a very large inventory of engagable services (reservables) in a minimum representation, and keeps the number as small as possible as new engagements are made and recorded.

Timespans, in the preferred embodiment, are represented within a computational class hierarchy, according to object-oriented programming techniques. The timespan classes, as described herein, represent a sequence of time intervals and the unique timespan algebra provided by the inventors provides mechanisms for compiling time span expressions and for manipulating and evaluating time span expressions. Timespan objects (instances of the said classes) are efficiently stored in the database as XML strings, or in other forms, and can represent things like: when a service is available, when a resource is available or when a supplier is available, as illustrated in FIG. 4a and as described above.

Each time span is half open, that is it includes its start time but does not including its end time. This is usually represented as [start, finish) in set theory. The time spans can be based on a Gregorian calendar or on absolute time, but they are stored and manipulated without a time zone. The time zone is added only when timespans are being “enumerated” to determine the actual time intervals they represent. Each instance of this class is immutable, allowing for caching of time space sequences.

FIG. 4b represents an alternative embodiment in which reservables, such as 85, 87, 89, 91 and 93 are represented as discrete reservable units, rather than as time spans or intervals. In this implementation many more expressions are required in the database than in the embodiment described from FIG. 4a. In the embodiment represented by FIG. 4b the system simply removes a discrete reservable each time an engagement transaction is made. Each transaction therefore reduces the number of reservables in the database.

The text language used to represent a timespan is based on XML, with the following syntax:

<timespan:DAILY fromHour=hh fromMinute=mm toHour=hh toMinute=mm/>

This expression represents a daily, half open span from the given hour and minute to the given hour and minute. For example,

<timespan:DAILY fromHour=15 toHour=17/>represents a 2 hour period from 3:00 pm to but not including 5:00 pm (half open).

A full day is represented by a Daily whose fromHour and fromMinute are equal to its toHour and toMinute values. The minute fields are optional, and the hour should be denoted in 24 hour time, i.e. 1 pm=>13. Note that the span may include midnight by having the end time precede the start time. Valid hour values are “0” to “23”, while the valid minute values are “0” to “59”.

<timespan:FIELD field=ff start=ss end=ee/>

This expression represents a half open interval in units determined by ff, which is a text representation of the fields from the java.util.Calendar class, e.g. hour, or day_of_week. The starting value for that field is start, and end is the ending value for that field. The end value may be less than the start value, which means that any value not in the range of end+1 to start−1 will match. The start and end values can be either numeric or string values(i.e., “1” or “February” or “Feb”). The numeric values for the months range from 0-11 (jan-dec), while the numeric values for the day_of_week range from 1-7 (sunday-saturday).

These values are not case sensitive. If the start value is equal to the end value, the time span sequence represents the timespan from the start value to and including the end value. For example, a Field timespan from hour 13 to hour 13 represents the daily timespan from 1:00 pm to but not including 2:00 pm.

<timespan:BETWEENMILLIS startTime=mmmmmmmmm endTime=mmmmmmmmm/>

represents a timespan from the given absolute time to the given absolute time. Note that the time may be given a decimal number of milliseconds from the Java epoch, or it can be given as a standard format date representation, always including a time zone parameter. The format of the date is “yyyy.M.d HH:mm:ss.SSS z”, i.e. “1999.5.11 12:11:12:322 PST”.

When specifying the time in standard date format, the string is enclosed in double quotes, i.e. <timespan:between millis startTime=“1999.5.11 12:11:12:322 PST” endTime:“1999.5.20 4:40:35.000 PST”>

<timespan. CAL year=yyyy month=m day_of_month=d hour_of_day=h minute=m second=s millisecond=m/>

represents a single point in time (which has no duration). Except for the “year” field, which is required, any subset of the above fields may be used to specify the date. Unspecified fields are given the Calendar's default values, which are typically the lowest possible value for that field (Month=jan, hour=1, etc). The values for the field “month” can be either numeric or string values (i.e. “Feb”, or “Feburary” or “1”), while the rest of the fields must be numeric values (those numeric values that are valid for these fields according to the java.util.Calendar class).

<timespan:DURATION field=ff distance=dd><CAL></timespan:DURATION>

represents a timespan beginning from CAL (a CAL timespan described above) and ending a time distance (in units of field) away. The field, ff, is a text representation of the fields from java.util.Calendar (i.e. hour, day_of_week,.), while the distance is a numeric value that is within the particular field's valid range. (i.e “1”-“7” for the day_of_week field). The duration timespan will add in the units of the specified field, and not necessarily the absolute time-duration represented by that field. For example, if one adds a month to Oct 30, the result would be Nov 31 (or a change of 31 days). However, if one adds a month to Nov 31, the result would be Dec 30 (or a change of 30 days).

<timespan:BETWEENCALS><CAL><CAL></timespan:BETWEENCALS>

represents a timespan ranging from the first encountered calendar tag to the second calendar tag.

<timespan:SMEAR field=ff distance=v><TS></timespan:SMEAR>

This is an operation that extends either the start or beginning of the timespan, TS, by the specified distance. The distance is in units of field.

<timespan:TRANSLATE field=ff distance=v><TS></timespan:TRANSLATE>

represents an operation that translates the enclosed timespan, TS, by the time distance, distance. The time distance is in units of field ff (i.e. month, year, day_of_week, . . . ). Distance can be either a positive or negative numeric value. The positive value translates the timespan forward in time, while the negative value translates the timespan backwards in time.

<timespan:UNION><TS1><TS1> . . . <TSn></timespan:UNION>

This is an operation that returns the timespan that is the union of the enclosed n timespans.

<timespan:INTERSECT><TS1><TS2> . . . <TSn></timespan:INTERSECT>

This is an operation that returns the timespan that is the intersect of the enclosed n timespans.

<timespan:SUBTRACT><TS><TS></timespan:SUBTRACT>

This is an operation that subtracts the second time span, the minuend, from the first timespan, the subtrahend.

<timespan:INVERSE><TS></timespan:INVERSE>

This is the inverse of its single argument time span.

<timespan:SIZEFILTER duration=d><TS></timespan:SIZEFILTER>

This operation filters out all spans of TS that are smaller than the value of duration. Duration is in units of milliseconds.

<timespan:REFERENCE ref=name>

represents a reference to another time span object defined somewhere else. The context should be implicit in the place where this object is being read in.

<timespan:EMPTY/>

represents the empty set (no time).

<timespan:UNIVERSE/>

represents all time from the theoretical beginning to ending.

Time Window Limitation

Another characteristic of the system of the invention in a preferred embodiment is the fact of a moving window of active data entities such as reservables and engagements. As described above, the time span by definition, and by construction in XML, is theoretically infinite in extent. For purposes of finite operations, a time window is imposed upon the database in a preferred embodiment, and operations are typically confined to the time window. This widow is theoretically of arbitrary extent, as well, and serves to limit the size of the data repository wherein reservables and some other data structures are stored and to therefore limit the computational cost of operations thereupon.

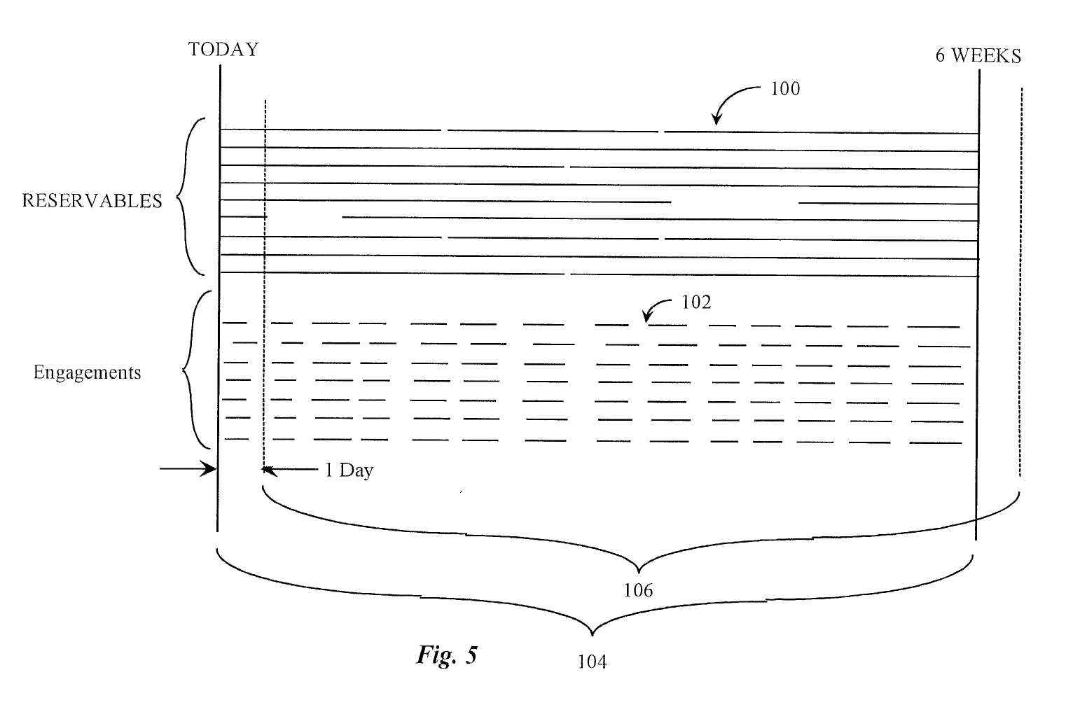

FIG. 5 is an illustration of a six-week time window 104 from today through a point six weeks hence showing reservables 100 and engagements 102 in the database. The reservables portion within the time window is the portion of the database that is searched to determine matches to a customer's request for service. The reservables 100 are created from resources available (instantiated), and in some cases defined against future expected resources, and are implemented in the database within the window at any particular time. Because each time-based reservable entity is a positive expression this implementation of a time window serves to limit the size of the active database, that is, the number of entities that have to be stored and searched. The skilled artisan will be aware, and it is clear from FIG. 2, that there are also many data entities in the database that are not time-based, such as supplier ID, service maps, and the like, but these entities are all finite by definition, and a time window is not necessary to limit their number.

In a preferred embodiment, referring now to FIG. 2, reservables are instantiated in the active time window on a periodic basis. The process is by timespan algebra, wherein unions and intersections of other entities represented in XML are determined to form reservables. A reservable may be thought of as an integration of a number of database entities, and is in fact generated by time span algebra operating on these data entities. Vertical categories (verticals 51) define service categories as generic to different classes of enterprise, such as medical, automotive, and so forth. These definitions serve to define specific services 49, which may be amended for specific suppliers to define supplier services 47, which now has the attributes of a supplier, the service definition, the vertical to which it belongs, cost, and duration. A supplier brings resources, such as Bunny and Melissa, for example, who have certain skills and availability expressed as timespans. A union of these produces resource capabilities, which is now to the level of a Melissa haircut, for example.

Timespan algebra as defined herein, and other data manipulations serve to update the data available to the system on a regular basis, then, at selected points in time, reservables are instantiated from these other data entities, and projected over the active time window of the system. It will be apparent to the skilled artisan that at the time of instantiating reservables, only the changes in data entities since the time of the last instantiation have to be considered.

Engagements are created in the database necessarily in real time, that is, at the time of the trailing moving edge of the time window, which is present time. However, since an engagement is a contract between a supplier and a customer for the supplier to provide a service at a future time and date, and for the customer to appear to take delivery of the service, and since there is typically a specific time start and end point for the engagement, engagements may be (and are in this embodiment) projected forward into the time widow as shown in FIG. 5.

In a preferred embodiment the system operates by moving the time window forward day by day, or on some other schedule. The window may be moved on a daily basis in some embodiments, and on a different schedule in others, or may be updated (reservables instantiated from other entities) on a continuous basis. There are a variety of calculations that are made in this process. For example, the day that passes and becomes yesterday no longer has reservables or engagements. One cannot engage a service to be performed in time past. At the same time, reservables are instantiated in the database for the time window when the window moves forward by a day, for example to the position shown by window 106 in FIG. 5.

In another aspect of the invention, the system, in addition to creating and recording engagements in the time window, also does accounting services relative to engagements. This process may begin in some cases at the point of engagement, because, in the system of the invention, in many cases the inventory may be marketed, sold, and accounted for by the enterprise hosting the system, rather than by individual suppliers. In other cases the beginning of such an accounting process may be delayed somewhat, but typically will start between the time the engagement is made and the time the engagement is consummated, that is, the service is actually delivered to the customer. In one case, the hosting enterprise contracts with suppliers for services, and becomes a service reseller, accounting for transactions with customers, and paying suppliers for services in bulk units. In many cases the accounting system in all of its various aspects, is separate from the database shown in FIG. 2, but cooperates and communicates with the database of FIG. 2 in performing the accounting and transactional functions.

Returning again to FIG. 5, the typical situation is that matching customer's requests to reservables, and recording of engagements all occurs within time window 104/106. There are, however, situations wherein a request for service may be beyond the time window, for example. There is also the situation wherein demand is large, and waiting lists may be created. In either of these cases, and perhaps others, operations may be made outside the moving time window, in which case reservables are generated dynamically by the system, now also necessarily accounting for existing reservations outside the time window, to determine service availability.

System Operations

Given the set of timespan expressions and the time span functions described above, a unique system and method for marketing and selling time-related inventory to customers is provided. In this system, inventory of reservable services (reservables) is semi-continuously created, and through presentation to customers seeking services, the reservables are matched with customer's requests, and after typically some negotiation, engagements are created, which are eventually consummated, at least to a great extent. By the unique nature of the system in embodiments of the invention, there is a unique variety in the transaction processes that may be accomplished.

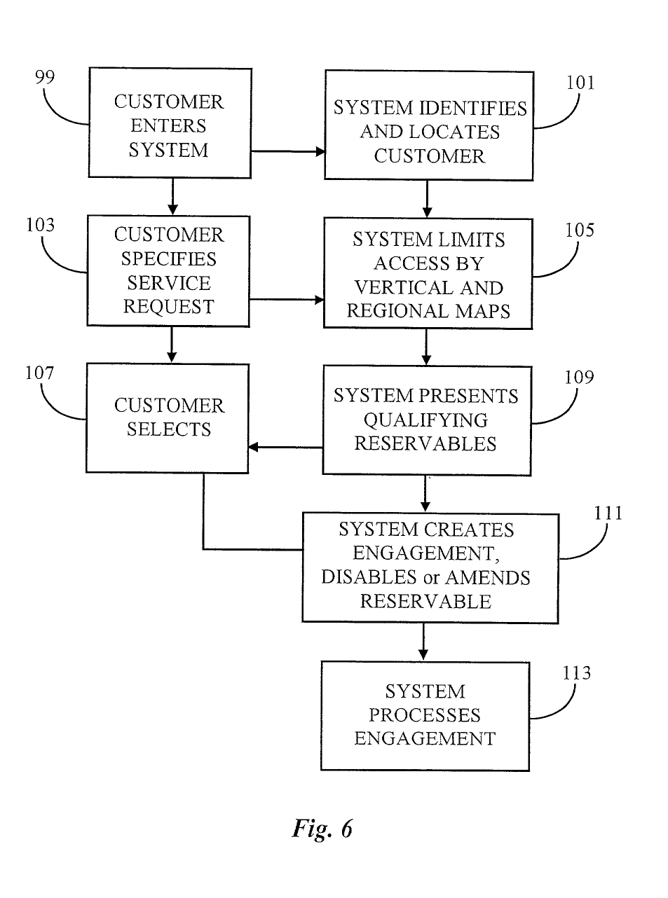

FIG. 6 is a process flow diagram illustrating one exemplary process flow in an embodiment of the invention. At step 99 a customer enters the system through an interface as described above. In the process, if the customer is known to the system, the system consults the database and identifies the customer at step 101. If the customer is new to the system the customer is prompted for certain information, before being entered to the system. In some cases the customer may not be allowed to enter the system.

In the initial customer interaction the system determines, as well, the customer location, also at step 101. This is an important criteria in most cases, because it is only the inventory local to the customer that may be of interest to the customer.

At step 103 the customer indicates his/her preference(s). The system consults a vertical map and regional keys (see FIG. 2) in step 105, and thus limits database interaction (searching) to a small portion of the stored data records, being those records that will be of interest to the customer. This ability to refine the search is of considerable importance. In some cases, as alluded to above, there will be no strict confinement to a specific region. A customer may be seeking services, for example, specifically in a region remote from the customer's home or business. These cases are handled by the nature of the customer requests, and by interaction by the system with the customer.

At step 109 the system, having performed the limited search, presents qualified reservables for the customer's selection. In this step, there may be incremental interaction between the system and the customer, and additional search steps as a result. At step 107 the customer makes a selection, and at step 111 the system creates a new engagement. The engagement is entered into the database, and becomes an object upon which the system may continue to act (113) until at least the time the engagement is consummated at a future date.

As described to some extent above, after making an engagement, the system must amend the reservables database. The reservable engaged is no longer available. In the case of discrete reservables (alternative embodiment) the system simply removes the reservable which was engaged by the customer. In the case of time-line reservables, the system amends the reservables appropriately to illustrate and offer the service not engaged in previous transactions.

In this process, the localization is not quite as simple as limiting all qualified reservables to a geographic region centered on the customer's address, for example, although this may often be the case. In many cases, the customer may specify a region remote from his/her locality. For example, a customer may be creating an itinerary, and wish to engage services in a faraway locale for certain dates. A customer might also engage services for another, such as a friend or a family member, in a different locale, and interface tools are provided by the system for these purposes.

Dynamic Pricing

Provision is made in the system for a number of novel functions. For example, pricing of time-based inventory may be dynamic. As a simple example of dynamic pricing of time-based inventory in this context, consider the six-week time window (exemplary), and the fact that all transactions with a customer occur now. The enterprise hosting the system may contract with suppliers for one price, say a fixed price over the time window period, but market the inventory at other prices. In the dynamic context there may be a relatively higher price for engagements within one to three days, a lesser price from three days to one week, and a sliding scale beyond one week, with engagements made six weeks out at a minimum price. There are many possibilities for time-based dynamic pricing. In another example, dynamic pricing may also be based on such as inventory level. Supply and demand becomes freely applicable, with the relative supply and the relative demand determining pricing, and mechanisms may be included for applying intelligence to pricing based on transaction history stored for a particular customer.

In another aspect, pricing may be varied by day of the week, time-of-day, or time-of the month or year, encouraging potential customers to purchase offered reservables at times that statistically support a lower level of purchase activity.

In yet another aspect pricing may be entirely flexible, as in any one of several types of auctions. Such an auction may be a straight auction, wherein the customer is provided interface tools for bidding on available time-based inventory. The controller of the auction may be the enterprise hosting the system of the invention, having pre-contracted for reservables. In other cases the hosting enterprise may act as an auctioneer for individual suppliers, who control their own pricing.

In another aspect time-based inventory may be offered by reverse auction, wherein customers list services they wish to engage, the system matches the listed services with reservables, and individual suppliers respond by bidding to provide the best price.

In yet another aspect time-based inventory may be subject to Dutch auction. Dutch Auctions are a special auction format where a supplier has multiple, identical services he or she wishes to sell. The seller specifies the minimum price (the starting bid) and the number of reservables available. Bidders bid at or above that minimum for the quantity they are interested in purchasing. At the close of the auction, the highest bidders purchase the items at the lowest successful bid.

Also, the enterprise hosting the system may enable customers to aggregate to increase their buying power. For instance, customers could place group reservations (engagements) at a volume discount, and the supplier(s) involved might service this reservation individually or all together. There are many alternative scenarios for dynamic pricing.

Special Circumstances in Transaction Matching

The unique model of the system of the present invention allows a number of services to be offered to potential customers that may not otherwise be available. For example, there are, in a preferred embodiment, automated wait lists for services that may not be currently available. Similar lists may be offered for highly desirable services, such as a table on a preferred evening at a desirable restaurant. In other cases, there may be a market for re-selling no-shows. For an upscale establishment, for example, the service of the invention may maintain a waiting list of people who are willing to respond quickly to, for example, take a table at a restaurant in place of a party that cancels or simply does not show up. The time frame differs for late and no-show, as well, and presents opportunities for dynamic pricing. In one embodiment the system of the invention may provide a service wherein customers agree to cancel within a time frame prior to the engagement time, or forfeit the price of the service, or at least a portion of the price of the service. In this situation, the broken engagement can still be resold if there is enough time.

In any of these cases engaging customers are notified when the service becomes available, and auction aspects may also have interplay. In some cases subscribing customers may be given preference according to purchase history and the like. In some embodiments the customer may specify the mode of contact preferred for alert that a reservable has become available, such as by telephone, facsimile, pager, and the like; or a combination of alert modes. In another embodiment reservables may be bundled, and the bundle treated and marketed as an entity.

Many such services, including automated yield management are services that may be supplied by the hosting enterprise to suppliers, and there are, in a preferred embodiment, pricing models for providing such services to supplier businesses.

Service Coloring and Shading According to Profile, History and Preference

As described above, suppliers are registered with and known to the hosting enterprise, and the host may make a broad variety of contractual relationships with suppliers. There will be, in many instances of the system, a single supplier, such as instances where the system is configured for one enterprise. Similarly, it was described above that customers, once they enter and use the system, become known to the system. The system in one aspect keeps continuously updated records of all transactions, and makes updates to both supplier and customer history. Many special services to both suppliers and customers may be predicated on such historical record. A customer with an active and regular purchase record will, in some embodiments, be offered special breaks, coupons, and the like, and may also be given priority in certain situations; where inventory becomes relatively scarce for a time, for example. In some cases there may be special relationships between suppliers and customers, and joint profile and history records may be kept and used. Certain suppliers may wish to accord VIP status to certain customers, and to provide special advantages to such customers.

In another aspect of the invention, for relatively scarce resources, the system may track engagements and demand; and in some cases customers holding engagements at an agreed-to price may be offered a takeback at a higher price, as the system will have a waiting customer willing to pay yet a higher price for the reservable. This service is also a part of yield management for certain subscribing suppliers.

There are other opportunities that may be pursued in the system relative to profiling as well, such as customer ranking (VIP), and such ranking may be shared among suppliers in some embodiments. The same kinds of ranking may apply to suppliers.

In another embodiment services are provided to customers enabling customers to barter and trade engagements, which may be viewed by customers as assets of variable value. The value of an engagement asset may be somewhat intrinsic, and also subject to customer taste. Opportunities exist, for example, for customers to purchase engagements, and resell or barter. In one sense, engagements may be treated as commodities or stocks, and traded as such.

The inventors are aware that the disclosure presented herein is a comprehensive disclosure, and the inventors believe that there are a relatively large number of inventions disclosed herein, some of which may be patentably distinct. The inventors have made an effort to present in this application only claims to a single patentably distinct invention. Other cases are or will be filed from this disclosure with other claim sets for examination.

In addition to the above, it will be apparent to the skilled artisan that there are many alterations that may be made to the embodiments described above while remaining within the spirit and scope of the invention. The claims presented below should therefore be accorded the widest possible scope.

What is claimed is:

1. In a database-driven transaction system, a dynamic-pricing mechanism for setting prices for timebased services offered and available through an interactive interface of the transaction system comprising:
a floating time window for identifying a span of time in which services are available to be engaged;
an averaging function for determining an average price paid to a single or multiple suppliers of services offered;
a scaling function for dividing the time window into definitive time units; and
a price-adjustment function for adjusting prices paid by customers for services according to position of engagement of said services within the time window.

2. The dynamic-pricing mechanism of claim 1, wherein the prices determined by the averaging function are paid by an entity hosting the transaction system.

3. The dynamic-pricing mechanism of claim 2, wherein the prices adjusted by the price-adjustment function are paid to the entity hosting the transaction system.

4. The dynamic-pricing mechanism of claim 3, wherein the prices adjusted by the price adjustment function are adjusted in a graduated fashion higher or lower depending on engaged position from a predetermined position within the time window.

5. The dynamic-pricing mechanism of claim 4, wherein the prices adjusted by the price adjustment function increase gradually according to engagement positions indicated serially from the predetermined position in the time window to the beginning of the time window.

6. The dynamic-pricing mechanism of claim 5, wherein the prices adjusted by the price adjustment function decrease gradually according to engagement positions indicated serially from the predetermined position in the time window to the end of the time window.

7. The dynamic-pricing mechanism of claim 1, wherein the time-window parameters are expressed in XML format.

8. The dynamic-pricing mechanism of claim 1, wherein the pricing parameters are expressed in XML format.

9. The dynamic-pricing mechanism of claim 1, wherein the time-window parameters and the pricing parameters are expressed as one of a family of SGML-based markup languages.

10. The dynamic-pricing mechanism of claim 1, wherein the time-window is displayable in a graphics format on a suitable display device connected to the transaction system.

11. The dynamic-pricing mechanism of claim 1, wherein the price-adjustment function is programmed to make pricing adjustments according to time-of-day, day-of-week, week-of-month, month-of-year, or a combination thereof.

12. The dynamic-pricing mechanism of claim 1, wherein the price-adjustment function is deactivated for the purpose of conducting one of a straight auction, a reverse auction, or a Dutch auction.

13. In a database-driven transaction system, a dynamic-pricing mechanism for setting prices for timebased services offered and available through an interactive interface of the transaction system comprising:
a floating time window for identifying a span of time in which services are available to be engaged;
a scaling function for dividing the time window into definitive time units;
an inventory quantifier for quantifying inventory levels of available services within the time window;
an averaging function for determining an average price paid to a single or multiple suppliers for services offered; and
a price-adjustment function for adjusting prices paid by customers for services according to an indicated level of inventory of said services quantified by the inventory quantifier and available within the time window.

14. The dynamic-pricing mechanism of claim 13, wherein the prices determined by the averaging function are paid by an entity hosting the transaction system.

15. The dynamic-pricing mechanism of claim 14, wherein the prices adjusted by the price-adjustment function are paid to the entity hosting the transaction system.

16. The dynamic-pricing mechanism of claim 15, wherein the prices adjusted by the price adjustment function are adjusted in a graduated fashion higher or lower depending on the indicated level of inventory of said services at the time of service engagement within the time window.

17. The dynamic-pricing mechanism of claim 16, wherein the prices adjusted by the price adjustment function increase gradually according to indication of gradually lower inventory levels as quantified by the inventory quantifier at the time of given service engagements within the time window.

18. The dynamic-pricing mechanism of claim 17, wherein the prices adjusted by the price adjustment function decrease gradually according to indication of gradually higher inventory levels as quantified by the inventory quantifier at the time of given service engagements within the time window.

19. The dynamic-pricing mechanism of claim 13, wherein the time-window parameters and the indicated inventory levels are expressed in XML format.

20. The dynamic-pricing mechanism of claim 13, wherein the pricing parameters are expressed in XML format.

21. The dynamic-pricing mechanism of claim 13, wherein the time-window parameters, the indicated inventory levels, and the pricing parameters are expressed as one of a family of SGML-based markup languages.

22. The dynamic-pricing mechanism of claim 13, wherein the time-window and indication of inventory levels are displayable in a graphics format on a suitable display device connected to the transaction system.

23. The dynamic-pricing mechanism of claim 13, wherein the price-adjustment function is deactivated for the purpose of conducting one of a straight auction, a reverse auction, or a Dutch auction.

24. The dynamic-pricing mechanism of claim 13, wherein the price-adjustment function is further programmed to make pricing adjustments according to time-of-day, day-of-week, week-of-month, month-of-year, or a combination thereof.

25. The dynamic-pricing mechanism of claim 13, wherein the price-adjustment function is further programmed to set prices according to quantity of a like inventory engaged by one customer.

26. In a database-driven transaction system, a method for determining a variable pricing structure for timebased services offered through an interactive interface of the system comprising the steps of:
(a) averaging actual prices paid to suppliers for services according to specific time units,
(b) providing a time window within the transaction system, the window dividable by the specific time units; and
(c) adjusting the actual prices paid by customers for service engagements established within the time window according to a preset sliding-scale rule implemented within the time window.

27. The method of claim 26 wherein in step (a), the prices determined by the averaging function are paid by an entity hosting the transaction system.

28. The method of claim 27 wherein in step (c), the prices adjusted by the price-adjustment function are paid to the entity hosting the transaction system.

29. The method of claim 28 wherein in step (a), the averaging function includes averaging prices set for disparate services offered by a single supplier.

30. The method of claim 29 wherein in step (a), the averaging function includes averaging prices set for disparate services offered by multiple suppliers.

31. The method of claim 30 wherein in step (c), the sliding-scale rule provides for increasing or decreasing prices depending on the position of potential service engagements identified within the time window from a predetermined position in the time window.

32. The method of claim 31 wherein in step (c), the sliding-scale rule dictates a gradual increase in price according to engagement positions indicated serially from the predetermined position in the time window to the beginning of the time window.

33. The method of claim 32 wherein in step (c), the sliding-scale rule dictates a gradual decrease in price according to engagement positions indicated serially from the predetermined position in the time window to the end of the time window.

34. The method of claim 30 wherein in step (a), price averaging includes the averaging of materials and labor.

35. The method of claim 34 wherein in steps (a) and (b), the expressions representing given prices and time-window parameters are XML expressions.

36. The method of claim 34 wherein in steps (a) and (b), the expressions representing given prices and time-window parameters are one of a family of SGML-based expressions.

37. The method of claim 34 wherein in step (b), the time-window is displayable in a graphics format on a suitable display device connected to the transaction system.

38. The method of claim 26, further comprising a step (d) for providing an indication of an inventory level associated with a defined timebased service available within the time window.

39. The method of claim 38, further comprising a step (e) for subsequent adjusting prices paid by customers according to given levels of inventory of available timebased services indicated within the time window.

40. The method of claim 39, further comprising a step (f) for temporarily deactivating steps (c) and (e) for the purpose of conducting one of a straight auction, a reverse auction, or a Dutch auction.

41. The method of claim 39, further comprising a step (f) for temporarily deactivating steps (c), and (e) for the purpose of adjusting prices paid by customers according to time-of-day, day-of-week, week-of-month, month-of-year, or a combination thereof.

42. The method of claim 39, further comprising a step (f) for performing subsequent adjustment of prices paid by customers according to engagement of a plurality of like services by one customer.
